(19) United States
(12) Patent Application Publication
(10) Pub. No.: US 2020/0090265 A1
(43) Pub. Date: Mar. 19, 2020

(54) CREDIT SCORE PLANNER SYSTEM AND METHOD

(71) Applicant: FAIR ISAAC CORPORATION, Roseville, MN (US)

(72) Inventors: Thomas Quinn, San Francisco, CA (US); Paul Panichelli, Holly Springs, GA (US); Prasanth Gopinathan, Milpitas, CA (US); Steven Y. Hu, San Jose, CA (US); Thomas Lee, Hercules, CA (US)

(21) Appl. No.: 16/359,815

(22) Filed: Mar. 20, 2019

Related U.S. Application Data
(60) Provisional application No. 62/654,178, filed on Apr. 6, 2018.

(51) Int. Cl. G06Q 40/02; G06F 16/904

(52) U.S. Cl. CPC G06Q 40/025; G06F 16/904

(57) ABSTRACT

Computer-implemented methods, systems and products, the method comprising determining an entity's credit score, the entity's credit score being based on a set of weighted score factors; receiving a target credit score and a target time duration for achieving the target credit score; generating, for display on a graphical user interface of a computing device, at least one of a planning statement or a set of action items based on an analysis of at least the entity's credit score in view of the target credit score and the target time duration.

### CROSS REFERENCE TO RELATED APPLICATIONS

Pursuant to 37 CFR § 119(e), this application claims priority to and incorporates by reference herein the entire contents of Provisional U.S. Patent Application Ser. No. 62/654,178 filed on Apr. 6, 2018, including all appendices filed therewith.

### COPYRIGHT & TRADEMARK NOTICES

A portion of the disclosure of this patent document may contain material, which is subject to copyright protection. The owner has no objection to facsimile reproduction by any one of the patent documents or the patent disclosure, as it appears in the Patent and Trademark Office patent files or records, but reserves all copyrights whatsoever.

Certain marks referenced herein may be common law or registered trademarks of the applicant, the assignee or third parties affiliated or unaffiliated with the applicant or the assignee. Use of these marks is for providing an enabling disclosure by way of example and shall not be construed to exclusively limit the scope of the disclosed subject matter to material associated with such marks.

### TECHNICAL FIELD

The subject matter described herein generally relates to credit scoring technology, and more particularly to a credit score planner.

### BACKGROUND

Credit ratings are widely used by banks and other financial institutions for assessing and reporting a measure of the creditworthiness of individual consumers. Often, credit scores are generated for an individual for a particular transaction, such as obtaining a mortgage or a loan, or opening up a new credit line.

To generate a credit score, a credit reporting agency (also commonly referred to as a credit bureau) applies a proprietary modeling algorithm to the credit data associated with an individual. The proprietary modeling algorithm used by the credit bureau is not known to the individual consumer. Therefore, it typically remains an unknown for an individual how exactly the score was calculated and what can be done to improve the score.

For example, certain score factors may affect a score more than others as some factors are weighed more favorably and others are weighed more adversely in relation to others. As such, there is a growing need to help consumers understand the factors impacting their score, what factors drove a change in score, as well as what set of actions they can take to potentially improve or increase their score.

### SUMMARY

For purposes of summarizing, certain aspects, advantages, and novel features have been described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be taught or suggested herein.

In accordance with some implementations of the disclosed subject matter, computer-implemented methods, systems and products are provided. The method comprises determining an entity's credit score, the entity's credit score being based on a set of weighted score factors; receiving a target credit score and a target time duration for achieving the target credit score; generating, for display on a graphical user interface of a computing device, at least one of a planning statement or a set of action items based on an analysis of at least the entity's credit score in view of the target credit score and the target time duration.

One or more action items in the set of action items may represent one or more actions that can be taken to achieve the target credit score by a suggested time duration associated with the target time duration, the one or more actions being associated with at least one of the weighted score factors. The suggested time duration may substantially match the target time duration. The suggested time duration may be shorter than the target time duration, in response to determining that the target credit score is achievable in a shorter timeframe than the target time duration. The suggested time duration may be longer than the target time duration, in response to determining that the target credit score is unachievable in the target time duration.

A less desirable target credit score than the target credit score may be suggested in the planning statement, in response to determining that the less desirable target credit score, instead of the target credit score, is achievable in approximately the target time duration. A more desirable target credit score than the target credit score may be suggested in the planning statement, in response to determining that the more desirable target credit score, instead of the target credit score, is achievable in approximately the target time duration. A different credit score than the target credit score may be suggested in the planning statement, in response to determining that the different credit score, instead of the target credit score, is achievable in a time duration that is different than the target time duration, but more practically achievable for the entity considering the entity's specific financial circumstances.

In example implementations, generating the at least one of the planning statement or the set of action items is dependent on the entity's credit score meeting a predetermined threshold; or generating the at least one of the planning statement or the set of action items is dependent on the target credit score being within a range of acceptable scores in relation to the entity's credit score. The set of action items may include one or more suggestions about improving the entity's credit score based on an analysis of the entity's credit bureau data in conjunction with the target credit score and the target time duration.

The details of one or more variations of the subject matter described herein are set forth in the accompanying drawings and the description below. Other features and advantages of the subject matter described herein will be apparent from the description and drawings, and from the claims. The disclosed subject matter is not, however, limited to any particular embodiment disclosed.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations as provided below.

FIG. 1 illustrates a credit score planning system, in accordance with one or more embodiments.

FIG. 2 is an example illustration of a user interface with which a user or consumer may interact to input or view credit planning data, in accordance with one or more embodiments.

FIG. 3 is an example flow diagram of a method for credit score planning, in accordance with one or more embodiments.

FIGS. 4A through 4G are example illustrations of a graphical user interface showing a variety of possible scenarios that may be presented to a consumer seeking to enhance or repair his or her credit score, in accordance with one or more embodiments.

FIG. 5 is a block diagram of a computing system that may be utilized to perform one or more computer processes disclosed herein as consistent with one or more embodiments.

The figures may not be to scale in absolute or comparative terms and are intended to be exemplary. The relative placement of features and elements may have been modified for the purpose of illustrative clarity. Where practical, the same or similar reference numbers denote the same or similar or equivalent structures, features, aspects, or elements, in accordance with one or more embodiments.

### DETAILED DESCRIPTION

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

In accordance with one or more variations, credit score planning systems and methods are provided that include a secure computing environment that allows a consumer to input a target credit score and an associated time horizon. These criteria, along with the consumer's credit report data elements, may be processed and analyzed to provide a set of actions the consumer can take to reach the target credit score.

In one or more embodiments, to generate a credit score, credit data associated with an individual is pre-sorted into one of a number of segments or scorecards within the overall modeling algorithm or credit scoring system. Each scorecard in the system may have a unique set of characteristics or attributes to be calculated from an individual's credit report data. Based on an algorithm and weighting scheme, a credit scoring system will generate a score within a range of scores.

Depending on where an individual's calculated score lands within the range of scores, the individual's creditworthiness is assessed. For instance, a score at a higher range indicates that the individual may be a very low credit risk and is likely to be extended credit by the bank or financial institution. Conversely, a score at a lower range indicates that the individual may be a very high credit risk, and is likely to be denied credit by the bank or financial institution. Credit scores have application in other areas as well, such as being a factor to determine the interest rate to charge for the loan or in determining a credit line adjustment.

Depending on implementation and the objective of the scoring system, a generated score may be based on a comprehensive set of categories of information from the credit report. For example, a score may be driven by a number of categories including, without limitation, payment history, amount of debt, length of credit history, type of new credit requested, and credit mix. A scoring algorithm may calculate characteristics from each of these categories, assign component score weights based on the characteristic values, and then produce an aggregate score.

When outputting a credit score, several factors (e.g., top five score factors) may be provided indicating the main reasons why the credit score was not higher or as expected. For example, a credit report can include a score, as well as a list of factors that have weighed adversely on that score, such as the number of late payments, the ratio of balance to available credit, or a duration over which certain credit accounts have been held by the individual. Such factors may be helpful to the individual for understanding what might be affecting the individual's credit score.

In accordance with one or more embodiments, a credit score planner (CSP) may be implemented as an online, secure computerized system and method that allows a consumer to input a target credit score and an associated time horizon. These criteria, along with the consumer's credit report data elements, are processed and analyzed within a credit score computing system to immediately output to a user interface a set of actions the consumer may take to reach that target score. The CSP, thus, allows the consumer to quickly understand if a target score within, for example, “x” time duration is feasible, and generates and provides a set of actions (e.g., based on action codes), which may be undertaken to potentially reach a target score.

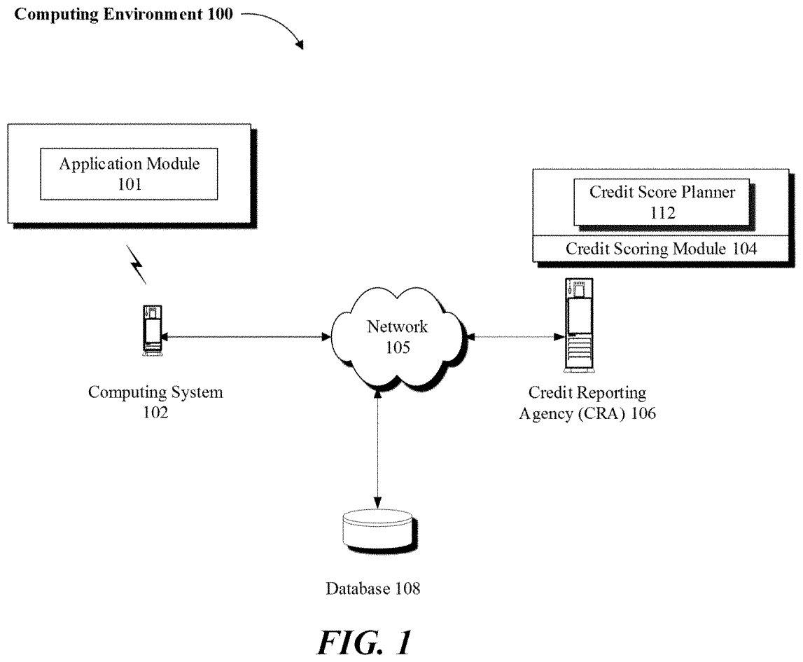

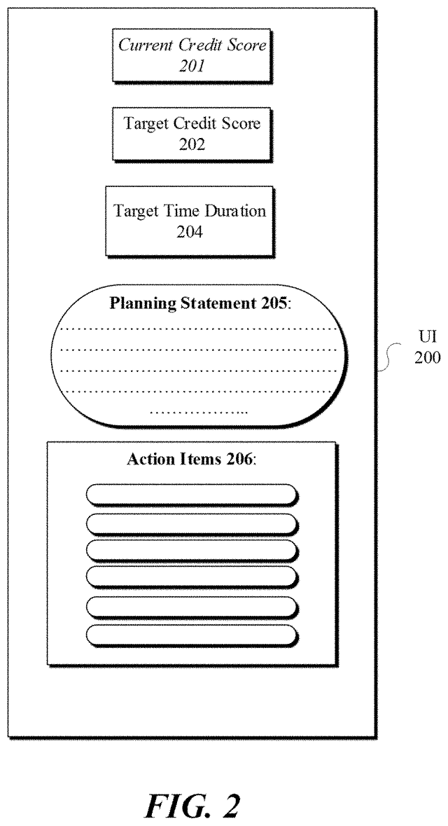

Referring to FIGS. 1 and 2, a computing environment 100 and user interface (UI) 200 are provided for facilitating a user's interaction with a CSP 112. As provided in further detail herein, consumer input may be processed to generate an output listing a set of actions for the consumer to take to reach, or get reasonably close, to the target credit score within a selected or proposed target time horizon. The computing environment 100 may include a computing system 102, which hosts application module 101 for processing user data input or applications received from a consumer or user.

Computing system 102 may be used, for example, directly by a consumer, or by a financial institution (e.g., a bank or other type of lender) to input data and process applications for credit, loan, or other financial instruments submitted by a user or consumer. Computing system 102 may communicate with a credit reporting agency (CRA) 106 via a network 105. The CRA 106 may host or execute a credit scoring module 104 that generates credit scores associated with one or more consumers.

In one or more implementations, the CRA 106 may include or be connected to a CSP 112 that receives a consumer's input, such as a target credit score and an associated time horizon, as received by the application module 101, for example. The time horizon may be defined by a target date in the future by which the consumer desires to achieve the target credit score. Depending on implementation, the CSP 112 may be implemented in software, firmware, or hardware to process the input data in view of the consumer's credit report data elements available to the CRA 106.

The collected consumer data may be analyzed by CSP 112 to determine a set of actions the consumer may take to potentially reach a target credit score. Accordingly, CSP 112 (in conjunction with the other elements of computing environment 100) may allow the consumer to quickly understand if a target score within the input time horizon is feasible. If so, CSP 112 generates and provides to a user interface a set of actions that the consumer can take to potentially reach the target credit score. Depending on implementation, the user interface may be incorporated as a part of application module 101 or a user device communicating with application module 101 or CSP 112, either directly or indirectly.

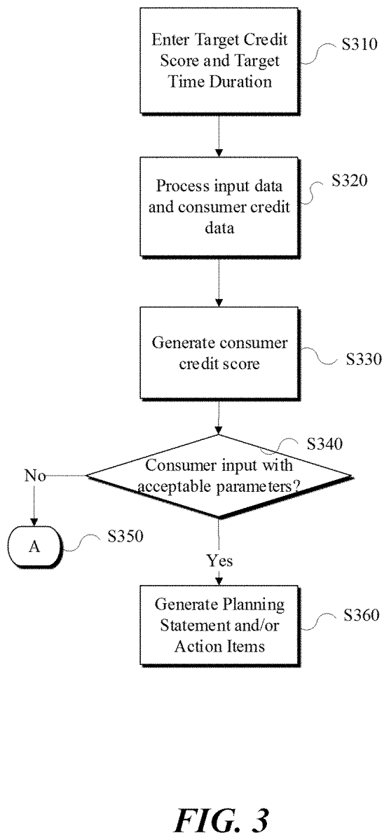

Referring to FIGS. 2 and 3, a consumer or another user may interact with UI 200 to input a variety of information, including a target credit score 202 and a target time duration 204 according to which the consumer desires to achieve the target credit score 202 (S310). The CSP 112 may analyze or process the data input by the user in conjunction with credit data available about the consumer (S320). Based on the analysis, CSP 112 may generate a current (i.e., up-to-date) credit score 201 for the particular consumer (S330). Depending on implementation, the CSP 112 may receive the target credit score 202 and the time duration 204 and execute a process that uses a credit scoring algorithm to generate the current credit score 201.

In some implementations, the data provided by the user or the consumer is analyzed to determine if the data is within acceptable parameters (S340). For example, the target credit score 202 entered by the consumer may need to be within an acceptable range, or otherwise may not be accepted (S350). In one example embodiment, the credit score 202 may need to be at least a certain number of points (e.g., 20 points) greater than the current credit score 201. For example, if a user's current credit score is 700, the target score selected by the user may need to be at least 720. Furthermore, the target credit score 202 may not be greater than a maximum allowable credit score (e.g., 850).

If the input provided through UI 200 is within acceptable parameters, one or more of planning statements 205 or a set of action items 206 may be generated indicating, with a certain level of accuracy, how to achieve the target credit score 202 within the target time duration 204 (S360). If the target credit score 202 is not achievable within the target time duration 204, the consumer may be offered alternative time duration selections from among a number of time horizons. In one example, UI 200 may provide a selection menu of 3, 6, 9 or 12 months for the target time duration 204.

In accordance with one or more embodiments, CSP 112 may not be made available or may not be able to provide suggestions to improve a credit score. For example, if the calculated current credit score for a consumer does not match a predetermined criteria, then the user may not be allowed to enter a target credit score 202 or target time duration 204. Thus, if consumer entered data 202, 204 or the calculated consumer credit score 201 falls outside a predetermined range (e.g., below a minimum or above a maximum threshold), the user may not be able to access CSP 112.

The CSP 112 may utilize an analytic decision tree to run through one or more scenarios to determine if, when or how the current credit score 201 may be improved to match the target credit score 202. In some implementations, an eligible simulation scenario hierarchy may be determined based on which suggested actions or informative guidelines may be displayed to the user as what a consumer can do to improve the current credit score. An example set of suggestions may include the following:
Pay bills on time for “x” months (this may be suggested, for example, if there is a balance >=$1 on any tradeline).
Do not open new tradeline for “x” months (this may be suggested, for example, if there is no balance on any tradeline).
Pay down “$y” of your total revolving/open account balances of “$y” every month for “x” months.
Increase your card limit by “$y”.

In the above examples, the suggested action or option for paying down card balances may be based on range of pay down percentages logic at the attribute levels (i.e., not exact dollar amounts) to mask exposure of the underlying proprietary credit scoring algorithm.

The suggestion to increase limits may be enacted based on a line increase strategy according to a credit score range as provided in the following set of examples:

If Score <670, suggest no line increase

If Score 670-689, suggest $500 line increase

If Score 690-719, suggest $1,000 line increase

If Score 720-749, suggest $1,500 line increase

If Score 750-799, suggest $2,000 line increase

If Score 800+, suggest $3,000 line increase

In some implementations, a user may run one or more target score scenarios to generate one or more simulated target scores. If the simulated target score for a scenario is less than a predetermined value, CSP 112 may not generate any feedback or suggestions as output. CSP 112 may automatically evaluate whether the target score entered by the user may be met in a shorter duration. If so, the output may include the simulated target score based on a shorter time duration. For example, if the user entered a desired target score of 700 to be achieved in 6 months, CSP 112 may determine that the desired target score of 700 may be met in a shorter time (e.g., in 3 months).

In one aspect, the CSP 112 may determine that a shorter timeline may be possible for achieving a target credit score, but may determine that the burden to reach that goal on the consumer may be unduly burdensome. For example, CSP 112 may determine that a target score of 700 may be achieved in 6 months as the user had requested, but the parameters for achieving the goal in the identified amount of time may require the user to pay down a certain debt at twice the monthly rate as currently scheduled. In such a scenario, CSP 112 may suggest a 9 or 12 month timeline with a payment schedule that is more realistic for the particular consumer.

Accordingly, in some scenarios, if the CSP 112 determines the target score entered cannot be met in the time duration selected, the CSP 112 may automatically evaluate if that target score may be met within a longer time duration (e.g., 15 months). Depending on implementation, if the calculated time duration for achieving the target credit goal is longer than a predetermined time duration (e.g., 24 months) then CSP 112 may not include any suggestions for that scenario. For example, if the user input indicates target score of 700 in 6 months and the analysis by the CSA 110 determines that the target score of 700 may be met in 26 months, suggestions for that scenario are not provided to the user.

In some implementations, N possible suggestions or action items (e.g., 6 action items) for improving a credit score may be provided to the user by the CSP 112. The following list is a non-limiting example of items that may be generated for viewing by a user, in accordance with various aspects:
Current credit score calculated for a consumer or user who desires to improve his score at the time the user provides user information to CSP 112
Target credit score (entered by the user)
Target time duration to improve credit score (entered by the user)
Simulated target score (calculated by CSP 112 based on credit history and credit information available for the user, and target credit score and target time duration data entered by the user)
Simulated time duration (calculated by CSP 112 factoring the simulated target score based on credit history and credit information available for the user, and target credit score and target time duration data entered by the user)
Planning statement
Action items or suggestions

The following are examples of content that may be generated in a planning statements:
Credit score is too low or inadequate for generating a plan.
The target credit score entered must be yyy points or higher than your current credit score and cannot exceed the maximum score of xyz.
A target credit score of zzz could be met within x months, if action items or suggestions provided are followed.
A slightly lower target credit score of zzz could be achieved within x months, if action items or suggestions provided are followed.
A higher target credit score of zzz could be met within x months, if action items or suggestions provided are followed.
A target credit score of zzz could be met within y months, instead of the x months you entered, if action items or suggestions provided are followed.
A target credit score of zzz could not be met within x months you entered, but could be met within y months, if action items or suggestions provided are followed.
A target credit score of zzz within x months cannot be met. Please enter a different target credit score or time duration.

Example action factors or suggestions that may be provided so that the consumer may attain the desired target credit score within the desired target timeframe may include:
Pay all your bills on time for “x” months
Continue to pay all your bills on time
Stay current on your payments so that your most recent delinquency is “x” years and “x” months
Stay current on your payments so that your most recent delinquency is deleted from your credit report
Do not open any new accounts, so that your average length of established history becomes x years and y months
Do not open any new accounts, so that the time since your most recently opened account becomes x years and y months
Pay down “$y” of your total revolving/open account balances every month for “x” months
Increase your card limit by “$y”
Do not apply for any new credit
Continue to make your monthly loan payments (e.g., mortgage, auto, personal loans and other reported installment loan balances) to reduce the total installment loan balances of $xxx,xxx you owe.

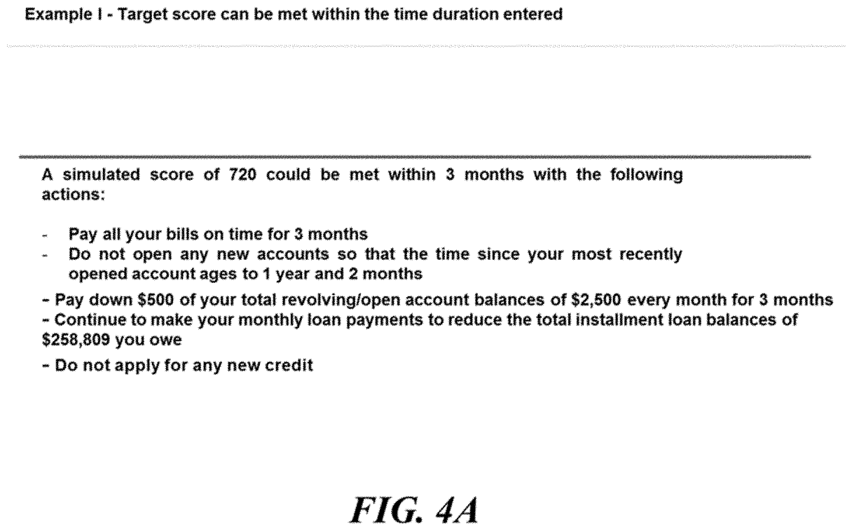

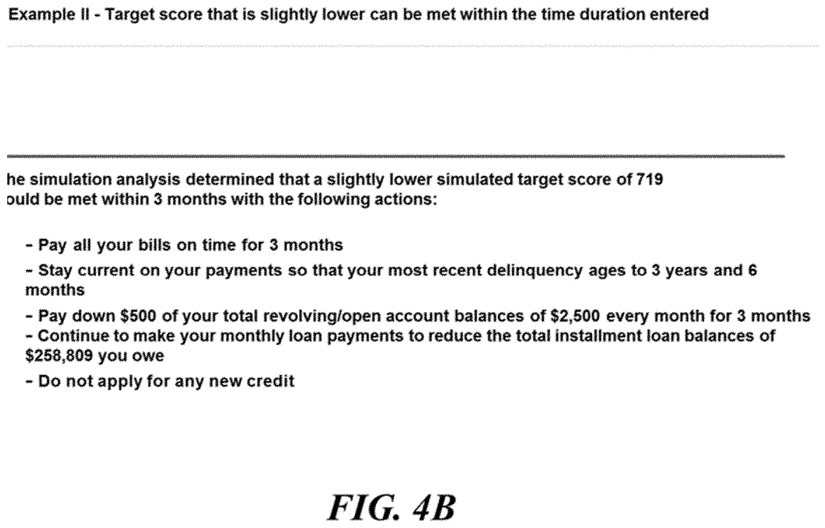

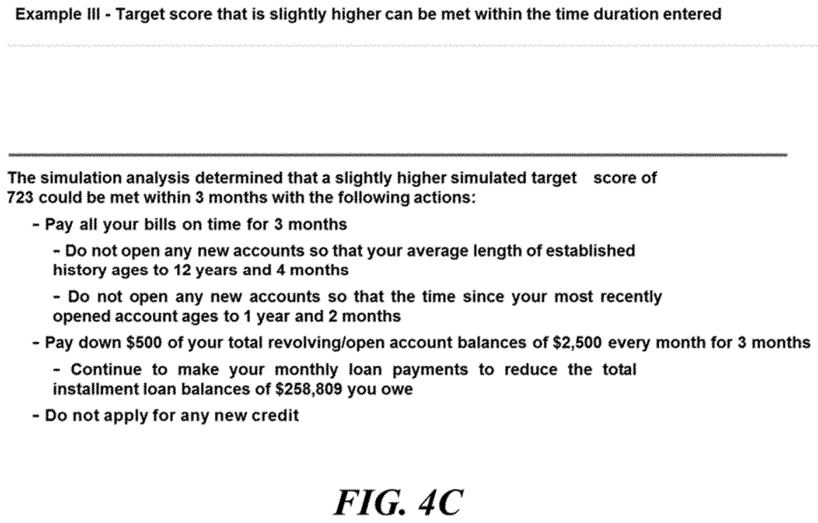

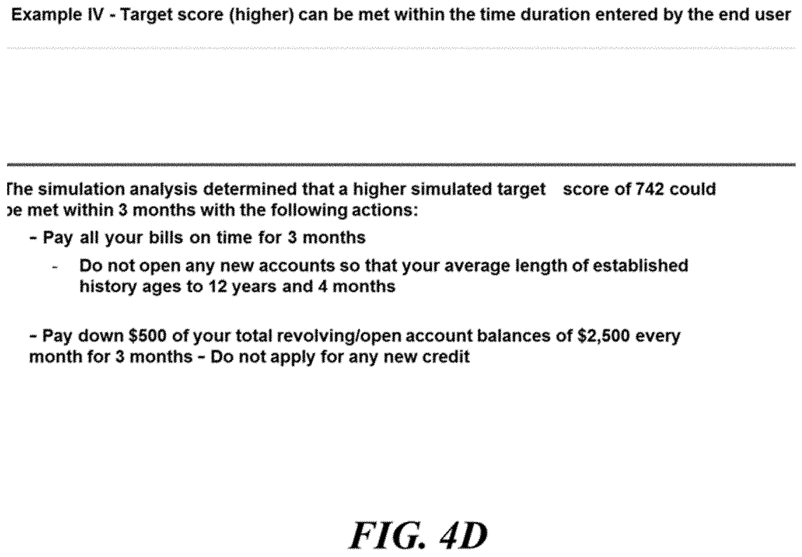

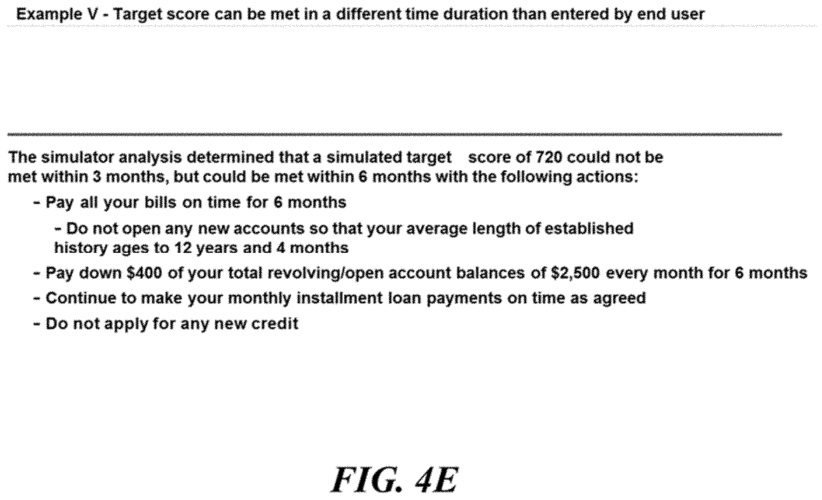

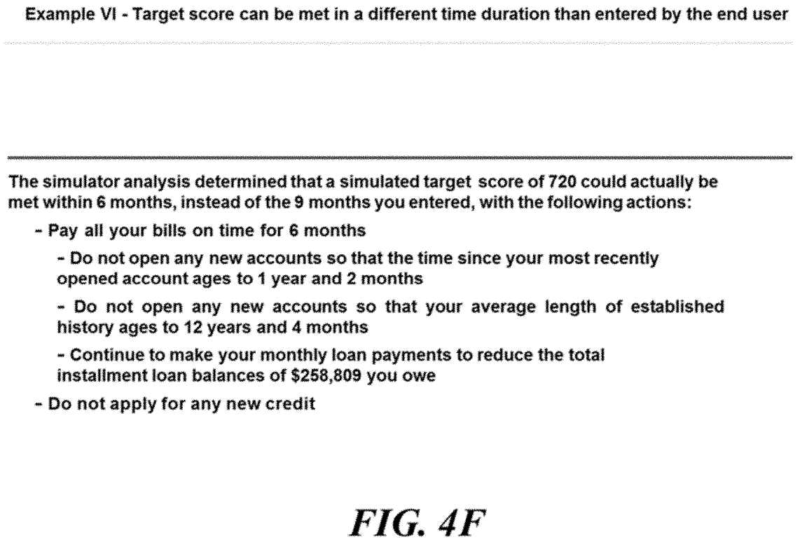

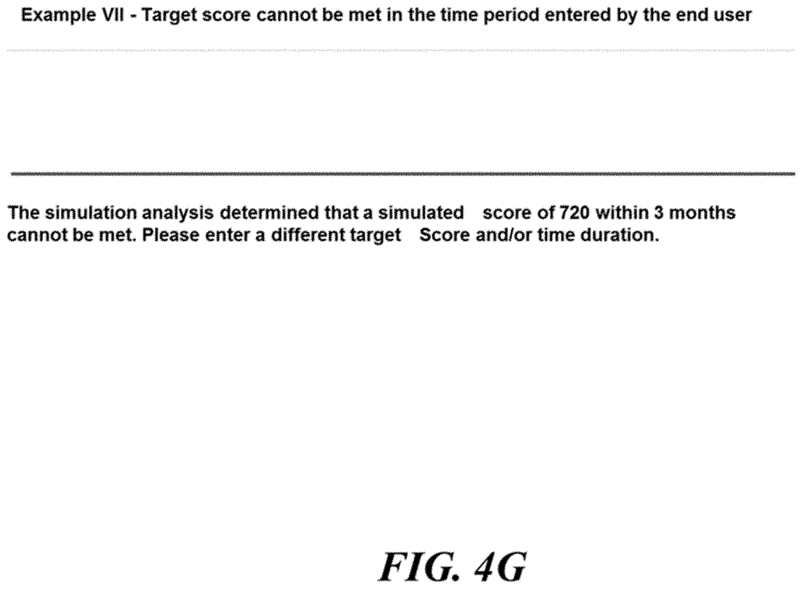

Referring to FIGS. 4A through 4G, example embodiments are illustrated in which a variety of different scenarios may be presented to a consumer seeking to enhance or repair his or her credit score.

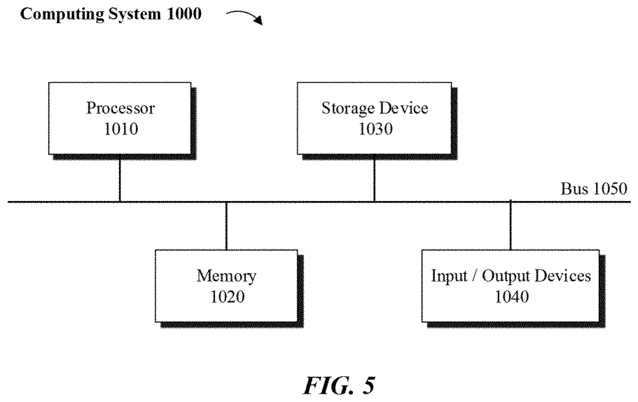

Referring to FIG. 5, a block diagram illustrating a computing system 1000 consistent with one or more embodiments is provided. The computing system 1000 may be used to implement or support one or more platforms, infrastructures or computing devices or computing components that may be utilized, in example embodiments, to instantiate, implement, execute or embody the methodologies disclosed herein in a computing environment using, for example, one or more processors or controllers, as provided below.

As shown in FIG. 5, the computing system 1000 can include a processor 1010, a memory 1020, a storage device 1030, and input/output devices 1040. The processor 1010, the memory 1020, the storage device 1030, and the input/output devices 1040 can be interconnected via a system bus 1050. The processor 1010 is capable of processing instructions for execution within the computing system 1000. Such executed instructions can implement one or more components of, for example, a cloud platform. In some implementations of the current subject matter, the processor 1010 can be a single-threaded processor. Alternately, the processor 1010 can be a multi-threaded processor. The processor 1010 is capable of processing instructions stored in the memory 1020 and/or on the storage device 1030 to display graphical information for a user interface provided via the input/output device 1040.

The memory 1020 is a computer readable medium such as volatile or non-volatile that stores information within the computing system 1000. The memory 1020 can store data structures representing configuration object databases, for example. The storage device 1030 is capable of providing persistent storage for the computing system 1000. The storage device 1030 can be a floppy disk device, a hard disk device, an optical disk device, or a tape device, or other suitable persistent storage means. The input/output device 1040 provides input/output operations for the computing system 1000. In some implementations of the current subject matter, the input/output device 1040 includes a keyboard and/or pointing device. In various implementations, the input/output device 1040 includes a display unit for displaying graphical user interfaces.

According to some implementations of the current subject matter, the input/output device 1040 can provide input/output operations for a network device. For example, the input/output device 1040 can include Ethernet ports or other networking ports to communicate with one or more wired and/or wireless networks (e.g., a local area network (LAN), a wide area network (WAN), the Internet).

In some implementations of the current subject matter, the computing system 1000 can be used to execute various interactive computer software applications that can be used for organization, analysis and/or storage of data in various (e.g., tabular) format (e.g., Microsoft Excel®, and/or any other type of software). Alternatively, the computing system 1000 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 1040. The user interface can be generated and presented to a user by the computing system 1000 (e.g., on a computer screen monitor, etc.).

One or more aspects or features of the subject matter disclosed or claimed herein may be realized in digital electronic circuitry, integrated circuitry, specially designed application specific integrated circuits (ASICs), field programmable gate arrays (FPGAs) computer hardware, firmware, software, and/or combinations thereof. These various aspects or features may include implementation in one or more computer programs that may be executable and/or interpretable on a programmable system including at least one programmable processor, which may be special or general purpose, coupled to receive data and instructions from, and to transmit data and instructions to, a storage system, at least one input device, and at least one output device. The programmable system or computing system may include clients and servers. A client and server may be remote from each other and may interact through a communication network. The relationship of client and server arises by virtue of computer programs running on the respective computers and having a client-server relationship to each other.

These computer programs, which may also be referred to as programs, software, software applications, applications, components, or code, may include machine instructions for a programmable controller, processor, microprocessor or other computing or computerized architecture, and may be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium may store such machine instructions non-transitorily, such as for example as would a non-transient solid-state memory or a magnetic hard drive or any equivalent storage medium. The machine-readable medium may alternatively or additionally store such machine instructions in a transient manner, such as for example as would a processor cache or other random access memory associated with one or more physical processor cores.

To provide for interaction with a user, one or more aspects or features of the subject matter described herein may be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices may be used to provide for interaction with a user as well. For example, feedback provided to the user may be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

### Terminology

When a feature or element is herein referred to as being “on” another feature or element, it may be directly on the other feature or element or intervening features and/or elements may also be present. In contrast, when a feature or element is referred to as being “directly on” another feature or element, there may be no intervening features or elements present. It will also be understood that, when a feature or element is referred to as being “connected”, “attached” or “coupled” to another feature or element, it may be directly connected, attached or coupled to the other feature or element or intervening features or elements may be present. In contrast, when a feature or element is referred to as being “directly connected”, “directly attached” or “directly coupled” to another feature or element, there may be no intervening features or elements present.

Although described or shown with respect to one embodiment, the features and elements so described or shown may apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments and implementations only and is not intended to be limiting. For example, as used herein, the singular forms “a”, “an” and “the” may be intended to include the plural forms as well, unless the context clearly indicates otherwise. It will be further understood that the terms “comprises” and/or “comprising,” when used in this specification, specify the presence of stated features, steps, operations, processes, functions, elements, and/or components, but do not preclude the presence or addition of one or more other features, steps, operations, processes, functions, elements, components, and/or groups thereof. As used herein, the term “and/or” includes any and all combinations of one or more of the associated listed items and may be abbreviated as “/”.

In the descriptions above and in the claims, phrases such as “at least one of or” one or more of may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

Spatially relative terms, such as “forward”, “rearward”, “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features due to the inverted state. Thus, the term “under” may encompass both an orientation of over and under, depending on the point of reference or orientation. The device may be otherwise oriented (rotated 90 degrees or at other orientations) and the spatially relative descriptors used herein interpreted accordingly. Similarly, the terms “upwardly”, “downwardly”, “vertical”, “horizontal” and the like may be used herein for the purpose of explanation only unless specifically indicated otherwise.

Although the terms “first” and “second” may be used herein to describe various features/elements (including steps or processes), these features/elements should not be limited by these terms as an indication of the order of the features/elements or whether one is primary or more important than the other, unless the context indicates otherwise. These terms may be used to distinguish one feature/element from another feature/element. Thus, a first feature/element discussed could be termed a second feature/element, and similarly, a second feature/element discussed below could be termed a first feature/element without departing from the teachings provided herein.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise.

For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, may represent endpoints or starting points, and ranges for any combination of the data points. For example, if a particular data point “10” and a particular data point “15” may be disclosed, it is understood that greater than, greater than or equal to, less than, less than or equal to, and equal to 10 and 15 may be considered disclosed as well as between 10 and 15. It is also understood that each unit between two particular units may be also disclosed. For example, if 10 and 15 may be disclosed, then 11, 12, 13, and 14 may be also disclosed.

Although various illustrative embodiments have been disclosed, any of a number of changes may be made to various embodiments without departing from the teachings herein. For example, the order in which various described method steps are performed may be changed or reconfigured in different or alternative embodiments, and in other embodiments one or more method steps may be skipped altogether. Optional or desirable features of various device and system embodiments may be included in some embodiments and not in others. Therefore, the foregoing description is provided primarily for the purpose of example and should not be interpreted to limit the scope of the claims and specific embodiments or particular details or features disclosed.

The examples and illustrations included herein show, by way of illustration and not of limitation, specific embodiments in which the disclosed subject matter may be practiced. As mentioned, other embodiments may be utilized and derived therefrom, such that structural and logical substitutions and changes may be made without departing from the scope of this disclosure. Such embodiments of the disclosed subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve an intended, practical or disclosed purpose, whether explicitly stated or implied, may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The disclosed subject matter has been provided here with reference to one or more features or embodiments. Those skilled in the art will recognize and appreciate that, despite of the detailed nature of the example embodiments provided here, changes and modifications may be applied to said embodiments without limiting or departing from the generally intended scope. These and various other adaptations and combinations of the embodiments provided here are within the scope of the disclosed subject matter as defined by the disclosed elements and features and their full set of equivalents.

What is claimed is:

1. A computer-implemented method comprising:
determining an entity's credit score, the entity's credit score being based on a set of weighted score factors;
receiving a target credit score and a target time duration for achieving the target credit score;
generating, for display on a graphical user interface of a computing device, at least one of a planning statement or a set of action items based on an analysis of at least the entity's credit score in view of the target credit score and the target time duration,
one or more action items in the set of action items representing one or more actions that can be taken to achieve the target credit score by a suggested time duration associated with the target time duration, the one or more actions being associated with at least one of the weighted score factors.

2. The method of claim 1, wherein the suggested time duration substantially matches the target time duration.

3. The method of claim 1, wherein the suggested time duration is shorter than the target time duration, in response to determining that the target credit score is achievable in a shorter timeframe than the target time duration.

4. The method of claim 1, wherein the suggested time duration is longer than the target time duration, in response to determining that the target credit score is unachievable in the target time duration.

5. The method of claim 1, wherein a less desirable target credit score than the target credit score is suggested in the planning statement, in response to determining that the less desirable target credit score, instead of the target credit score, is achievable in approximately the target time duration.

6. The method of claim 1, wherein a more desirable target credit score than the target credit score is suggested in the planning statement, in response to determining that the more desirable target credit score, instead of the target credit score, is achievable in approximately the target time duration.

7. The method of claim 1, wherein a different credit score than the target credit score is suggested in the planning statement, in response to determining that the different credit score, instead of the target credit score, is achievable in a time duration that is different than the target time duration, but more practically achievable for the entity considering the entity's specific financial circumstances.

8. The method of claim 1, wherein generating the at least one of the planning statement or the set of action items is dependent on the entity's credit score meeting a predetermined threshold.

9. The method of claim 1, wherein generating the at least one of the planning statement or the set of action items is dependent on the target credit score being within a range of acceptable scores in relation to the entity's credit score.

10. The method of claim 1, wherein the set of action items includes one or more suggestions about improving the entity's credit score based on an analysis of the entity's credit bureau data in conjunction with the target credit score and the target time duration.

11. A system comprising:
at least one programmable processor; and
a non-transitory machine-readable medium storing instructions that, when executed by the at least one programmable processor, cause the at least one programmable processor to perform operations comprising:
determining an entity's credit score, the entity's credit score being based on a set of weighted score factors;
receiving a target credit score and a target time duration for achieving the target credit score;
generating, for display on a graphical user interface of a computing device, at least one of a planning statement or a set of action items based on an analysis of at least the entity's credit score in view of the target credit score and the target time duration,
one or more action items in the set of action items representing one or more actions that can be taken to achieve the target credit score by a suggested time duration associated with the target time duration, the one or more actions being associated with at least one of the weighted score factors.

12. The system of claim 11, wherein the suggested time duration substantially matches the target time duration.

13. The system of claim 11, wherein the suggested time duration is shorter than the target time duration, in response to determining that the target credit score is achievable in a shorter timeframe than the target time duration.

14. The system of claim 11, wherein the suggested time duration is longer than the target time duration, in response to determining that the target credit score is unachievable in the target time duration.

15. The system of claim 11, wherein a less desirable target credit score than the target credit score is suggested in the planning statement, in response to determining that the less desirable target credit score, instead of the target credit score, is achievable in approximately the target time duration.

16. A computer program product comprising a non-transitory machine-readable medium storing instructions that, when executed by at least one programmable processor, cause the at least one programmable processor to perform operations comprising:
determining an entity's credit score, the entity's credit score being based on a set of weighted score factors;
receiving a target credit score and a target time duration for achieving the target credit score;
generating, for display on a graphical user interface of a computing device, at least one of a planning statement or a set of action items based on an analysis of at least the entity's credit score in view of the target credit score and the target time duration,
one or more action items in the set of action items representing one or more actions that can be taken to achieve the target credit score by a suggested time duration associated with the target time duration, the one or more actions being associated with at least one of the weighted score factors.

17. The computer program product of claim 16, wherein the suggested time duration substantially matches the target time duration.

18. The computer program product of claim 16, wherein the suggested time duration is shorter than the target time duration, in response to determining that the target credit score is achievable in a shorter timeframe than the target time duration.

19. The computer program product of claim 16, wherein the suggested time duration is longer than the target time duration, in response to determining that the target credit score is unachievable in the target time duration.

20. The computer program product of claim 16, wherein a less desirable target credit score than the target credit score is suggested in the planning statement, in response to determining that the less desirable target credit score, instead of the target credit score, is achievable in approximately the target time duration.
